(19) United States
(12) Patent Application Publication
(10) Pub. No.: US 2026/0327756 A1
(43) Pub. Date: Oct. 22, 2026

(54) RARE EARTH SINTERED MAGNET

(71) Applicant: SHIN-ETSU CHEMICAL CO., LTD., Tokyo (JP)

(72) Inventors: Yosuke Shinada, Echizen-shi (JP); Akira Yamada, Echizen-shi (JP); Akihiro Yoshinari, Echizen-shi (JP); Kazuya Fukui, Echizen-shi (JP); Koichi Hirota, Echizen-shi (JP)

(73) Assignee: SHIN-ETSU CHEMICAL CO., LTD., Tokyo (JP)

(21) Appl. No.: 19/491,057

(22) PCT Filed: Jun. 11, 2024
(86) PCT No.: PCT/JP2024/021127

§ 371 Date: Dec. 8, 2025

(30) Foreign Application Priority Data
Jun. 14, 2023 (JP) 2023-097718

(51) Int. Cl. C22C 38/00; B22F 3/16; B22F 9/02; B22F 9/04; C22C 33/04; C22C 38/06; C22C 38/10; C22C 38/14; C22C 38/16; H01F 1/057

(52) U.S. Cl. CPC C22C 38/005; B22F 3/16; B22F 9/023; B22F 9/04; C22C 33/04; C22C 38/001; C22C 38/002; C22C 38/06; C22C 38/10; C22C 38/14; C22C 38/16; H01F 1/0577; B22F 2009/042; B22F 2009/044; B22F 2201/02; B22F 2201/20; B22F 2202/05; B22F 2301/355; B22F 2998/10; B22F 2999/00; C22C 2202/02

(57) ABSTRACT

The rare earth sintered magnet is characterized by satisfying the relational expression (1): [RGB]=[R]−[Fe]/7, the relational expression (2): [M1]=[Co]+[Cu]+[Ga], the relational expression (3): 1.0<[RGB]/[M1]<2.4, and the relational expression (4): [Cu]+[Ga]≥0.28, where [R], [Fe], [Co], [Cu], [Ga], and [M1] are the respective atomic percentages of R (one or more rare earth elements essentially including Nd), Fe, Co, Cu, Ga, and M1 (two or more elements selected from among Co, Cu, and Ga, and essentially including Co), and [RGB] is the atomic percentage of R contributing to the formation of the grain boundary phase, in an arbitrary region within the depth range of 0.1-200 μm from the surface of the magnet. As a result, a rare earth sintered magnet which has high magnetic characteristics and excellent corrosion resistance can be obtained.

### TECHNICAL FIELD

The present invention relates to a sintered rare earth magnet having high magnetic properties and excellent corrosion resistance.

### BACKGROUND ART

Sintered rare earth magnets are functional materials which are necessary and indispensable for greater energy efficiency and higher functionality, and their range of use and production volume are growing from year to year. Among sintered rare earth magnets, sintered neodymium magnets in particular have a high residual magnetic flux density (also referred to below as Bᵣ) and are being used in a variety of applications and environments, including drive motors for hybrid cars and electric cars, power steering motors, air conditioner compressor motors, and voice coil motors (VCM) for hard disk drives.

At the same time, a problem with sintered rare earth magnets is that, because they contain rare earth elements R, they tend to corrode. Corrosion is known to originate at some R-rich phases and to proceed further with main phase separation. Given the demand in recent years for high magnetic properties in rare earth magnets, there is a need to reduce impurity elements included in the magnets to the lowest possible level. This is accompanied by a tendency for the amount of effective R included in sintered rare earth magnets to increase and for the corrosion resistance to decrease. When such magnets are used in automotive water pumps in particular, because the magnets built into the motor are used in a harsh environment where they come into direct contact with antifreeze, they must have both good magnetic properties and a high corrosion resistance. Various art has been proposed to this end.

For example, JP-A 2007-300791 (Patent Document 1) discloses a method which, by forming an electroplated nickel film on the magnet surfaces, imparts high corrosion resistance that enables use even in water.

JP-A 2020-102551 (Patent Document 2) discloses art which, by having copper be present at the grain boundaries in such a way that the concentration gradient decreases from the surface of the magnet towards the interior and by providing an oxide layer at grain boundaries in regions at a depth of 0.1 to 5 μm from the surface, enhances the corrosion resistance of the magnet within a water pump.

JP-A 2021-61301 (Patent Document 3) states that a high corrosion resistance can be achieved by forming a microstructure in which the rare earth element content of the magnet's grain boundary phases overall is at least 55 wt % and copper-rich regions containing at least 8 wt % copper account for at least 9 vol % of the grain boundary phases.

### PRIOR ART DOCUMENTS

### Patent Documents

Patent Document 1: JP-A 2007-300791
Patent Document 2: JP-A 2020-102551
Patent Document 3: JP-A 2021-61301

### SUMMARY OF INVENTION

### Technical Problem

However, when a method that forms a nickel plating layer as described in Patent Document 1 is employed, carrying out a plating process increases costs. Moreover, there is a concern that, when plating defects arise, the magnet will end up disintegrating upon direct exposure to the operating environment.

In the method described in Patent Document 2, owing to the need to carry out the grain boundary diffusion of a copper-containing R alloy in order to form the prescribed microstructure and the need to form a surface oxide layer, the increased number of steps leads to higher costs.

Finally, in the method described in Patent Document 3, it is necessary to form grain boundary phases which contain heavy rare earth element-containing rare earth elements, copper, and iron or transition metal (T) in which some of the iron is substituted with cobalt. However, not including heavy rare earth elements is especially preferable because of their high resource risk and high prices.

The present invention was conceived in light of the above issues. The object of the invention is to provide a sintered rare earth magnet which has high magnetic properties and excellent corrosion resistance by forming a region of specific composition at the surface of the magnet.

### Solution to Problem

In order to achieve this object, the inventors have conducted repeated and intensive investigations focused on the composition of sintered rare earth magnets, especially the relationship between the contents of R elements and M elements (cobalt, copper, gallium) that contribute to the formation of grain boundary phases in a specific region near the surface of the magnet. As a result, they have discovered that, by lowering the R content or adding at least a given amount of M elements, intermetallic compounds of R and M elements within the grain boundary phases form and R metal phases disappear, enhancing the corrosion resistance. This discovery ultimately led to the present invention.

Accordingly, this invention provides the following sintered rare earth magnet.
1. A sintered rare earth magnet containing R (wherein R is one or more element selected from the rare earth elements, with neodymium being essential), iron, boron, M1 (wherein M1 is two or more elements selected from cobalt, copper and gallium, with cobalt being essential), M2 (wherein M2 is one or more element selected from aluminum, silicon, chromium, manganese, zinc, germanium, molybdenum, tin, tungsten, lead and bismuth) and oxygen,
wherein the oxygen is included in an amount of 0.6 at % or less, and
   the sintered rare earth magnet has a plurality of main-phase grains consisting of a R₂Fe₁₄B intermetallic compound, an R-containing grain boundary phase positioned between at least two of the main-phase grains, and a region which, letting [R], [Fe], [Co], [Cu], [Ga] and [M1] be the atomic percentages of, respectively, R, iron, cobalt, copper, gallium and M1 in at least some portion of the range in depth of 0.1 to 200 μm from a surface of the magnet and letting [R_{GB}] be the atomic percentage of R which contributes to formation of the grain boundary phase, satisfies formulas (1) to (4) below.

[R_{GB}]=[R]−[Fe]/7 (1)

[M1]=[Co]+[Cu]+[Ga] (2)

1.0<[R_{GB}]/[M1]<2.4 (3)

[Cu]+[Ga]≥0.28 (4)
2. The sintered rare earth magnet of 1 above wherein, letting S be the surface area of the magnet and S_{R} be the surface area obtained by projecting onto an adjoining surface of the magnet the region that satisfies formulas (1) to (4) in the range in depth of 0.1 to 200 μm from the magnet surface, the sintered rare earth magnet satisfies formula (5) below.

0.53≤S_{R}/S≤1 (5)
3. The sintered rare earth magnet of 1 or 2 above, wherein the content of R metal phase having an R content of from 50 to 70 at % within the grain boundary phase is 3 vol % or less.
4. The sintered rare earth magnet of any of 1 to 3 above, further containing from 0.1 to 2.0 at % of M3 (wherein M3 is one or more element selected from titanium, vanadium, zirconium, niobium, hafnium and tantalum).
5. The sintered rare earth magnet of 4 above wherein, letting [B] be the atomic percentage of B and [M3] be the atomic percentage of M3, the magnet satisfies formula (6) below.

[B]−2×[M3]≥[Fe]/14 (6)
6. The sintered rare earth magnet of any of 1 to 5 above, wherein the carbon is included in an amount of 0.4 at % or less.
7. The sintered rare earth magnet of any of 1 to 6 above, wherein the nitrogen is included in an amount of 0.4 at % or less.
8. The sintered rare earth magnet of any of 1 to 7 above, wherein the main-phase grains have an average crystallite size, determined as the equivalent circle diameter in a plane parallel to the direction of magnetization, of 4 μm or less.
9. The sintered rare earth magnet of any of 1 to 8 above, wherein the magnet has a percent weight loss, as determined by the method of immersing and sealing, in a 1:1 by volume ethylene glycol-water mixture, a sample cut from the magnet in the shape of a rectangular parallelepiped having dimensions of 5 mm×5 mm×2 mm, holding the immersed sample in the sealed state at 120°C for 480 hours and measuring the percent loss in the sample weight, of 1 wt % or less.

### Advantageous Effects of Invention

This invention makes it possible to obtain sintered rare earth magnets which can be conferred with high corrosion resistance without the formation of a protective film by a post-treatment step, and which are outstanding in terms of cost because a grain boundary diffusion step using heavy rare earth elements is not always necessary.

### BRIEF DESCRIPTION OF DRAWINGS

FIG. 1 is a graph showing the relationship between the [R_{GB}]/[M1] value and percent weight loss in Examples according to the invention and Comparative Examples.

### DESCRIPTION OF EMBODIMENTS

The sintered rare earth magnet of the invention contains R (wherein R is one or more element selected from the rare earth elements, with neodymium being essential), iron, boron, M1 (wherein M1 is two or more elements selected from cobalt, copper and gallium, with cobalt being essential), M2 (wherein M2 is one or more element selected from aluminum, silicon, chromium, manganese, zinc, germanium, molybdenum, tin, tungsten, lead and bismuth) and oxygen.

As noted above, R is one or more element selected from the rare earth elements, with neodymium being essential. To keep a-Fe crystallization from occurring in the raw material alloy at the time of production and fully carry out densification, the content of R is preferably at least 12.5 at %, and more preferably at least 13.0 wt %. Although eliminating α-Fe is difficult even when homogenization is carried out, within the above range, large decreases in the coercivity (also referred to below as H_{cJ}) and squareness of sintered R-T-B magnets can be avoided. This is the same even when the raw material alloy is produced by strip casting, where α-Fe crystallization does not readily arise. In addition, a decrease in sinterability and insufficient densification of sintered R-T-B magnets owing to a decline in the amount of liquid phase composed primarily of R constituents, the role of which is to promote densification in the subsequently described sintering process, can be prevented. On the other hand, when the R content is too high, the proportion of R₂T₁₄B phase within the sintered magnet becomes low and the Bᵣ decreases. Therefore, to prevent such a decrease in Bᵣ, it is preferable for the R content to be not more than 17 at %, more preferably not more than 15.5 at %, and even more preferably not more than 15 at %.

The proportion of neodymium in R is not particularly limited, although it is preferably at least 60 at %, and more preferably at least 75 at %, of all the R elements. There is no particular limitation on the R elements other than neodymium, although elements such as praseodymium, dysprosium, terbium, holmium, erbium, samarium, cesium and yttrium may be preferably included.

The iron serves as the balance of the composition other than the above constituents R, boron, M1, M2 and oxygen. To obtain a higher Bᵣ, the iron content is preferably at least 70 at %, and more preferably at least 75 at %. The iron content is not particularly limited, although to keep the squareness from worsening due to the precipitation of R₂T₁₇ phases and to keep the H_{cJ} from decreasing, it is preferably not more than 82 at %, and more preferably not more than 80 at %.

The boron content is preferably 5.0 at % or more, more preferably 5.5 at % or more, and even more preferably 5.7 at % or more. Within such a range, the proportion of the R₂T₁₄B phase that forms becomes low, and so a large decrease in Bᵣ and worsening of the squareness due to the formation of R₂T₁₇ phases can be suppressed. On the other hand, the upper limit is preferably not more than 7.0 at %, more preferably not more than 6.5 at %, and even more preferably not more than 6.3 at %. Within such a range, a R_{1.1}T₄B₄ compound phase forms and decreases in Bᵣ and H_{cJ} are easily avoided. Some of the above boron may be substituted with carbon.

As noted above, M1 is two or more elements selected from cobalt, copper and gallium, with cobalt being essential. By including M1, a high corrosion resistance can be obtained. The content of M1 is preferably at least 1.0 at %, and more preferably at least 1.5 at %. In this way, the formation of compounds of R and M1 is sufficiently carried out, enabling the formation of R metal phases having a high R concentration to be suppressed and thus resulting in improved corrosion resistance. The upper limit is preferably not more than 3.5 at %, and more preferably not more than 3.0 at %. This enables decreases in Bᵣ and H_{cJ} to be suppressed.

The above cobalt may take the place of some of the iron included in the R₂T₁₄B phase and the grain boundary phases. The content of cobalt, from the standpoint of the Curie temperature and to obtain a corrosion resistance-enhancing effect, is preferably at least 0.5 at %, and more preferably at least 1.0 at %, of the overall magnet. To stably obtain a high H_{cJ}, the cobalt content is preferably not more than 3.0 at %, and more preferably not more than 2.0 at %.

The content of copper, from the standpoint of obtaining an optimal temperature range in heat treatment in order to ensure good productivity and from the standpoint of obtaining a corrosion resistance-enhancing effect, is preferably at least 0.1 at %, and more preferably at least 0.2 at %, of the overall magnet. To stably obtain a high Bᵣ, the copper content is preferably not more than 1.0 at %, and more preferably not more than 0.5 at %.

The content of gallium, from the standpoint of obtaining an optimal temperature range in heat treatment in order to ensure good productivity and from the standpoint of obtaining a corrosion resistance-enhancing effect, is preferably at least 0.1 at %, and more preferably at least 0.2 at %, of the overall magnet. To stably obtain a high Bᵣ, the gallium content is preferably not more than 1.0 at %, and more preferably not more than 0.5 at %.

As noted above, M2 is one or more element selected from aluminum, silicon, chromium, manganese, zinc, germanium, molybdenum, tin, tungsten, lead and bismuth. The content of M2, from the standpoint of obtaining an optimal temperature range in heat treatment in order to ensure good productivity and also from the standpoint of suppressing a decrease in H_{cJ}, is preferably 0.1 at % or more, and more preferably 0.2 at % or more. Also, to obtain a high Bᵣ, the content is preferably not more than 1.5 at %, and more preferably not more than 1.0 at %.

The content of oxygen, from the standpoint of obtaining a high room-temperature H_{cJ}, is not more than 0.6 at %, preferably not more than 0.4 at %, and more preferably not more than 0.3 at %. At a content greater than 0.6 at %, the amount of R—OCN phase and R₂O₃ phase formation rises, as a result of which the effective amount of R that functions as a liquid phase decreases, lowering the H_{cJ}.

The sintered rare earth magnet of the invention may include also optional elements other than the above R, iron, boron, M1, M2 and oxygen. The M3, carbon, nitrogen and other elements mentioned below may be included as such optional elements.

M3 is one or more element selected from titanium, vanadium, zirconium, niobium, hafnium and tantalum. In sintered rare earth magnets, the M3 elements together with boron form M3B₂ compounds and exhibit an abnormal grain growth-suppressing effect during sintering. The content of M3, although not particularly limited, is preferably at least 0.1 at %, more preferably at least 0.2 at %, and even more preferably at least 0.3 at %. On the other hand, to avoid decreases in Bᵣ and H_{cJ} due to insufficient boron for forming the main phase, the content is preferably not more than 2.0 at %, more preferably not more than 1.5 at %, and even more preferably not more than 1.0 at %. In addition, from the above standpoints, letting [B] and [M3] be the atomic percentages of boron and M3, the sintered rare earth magnet preferably satisfies formula (6) below.

[B]−2×[M3]≥[Fe]/14 (6)

The above carbon comes from the raw materials and from lubricants and the like that are added to improve the orientability of the fine powder in powder compact formation within a magnetic field. However, carbon from lubricants is decomposed and removed in the subsequently described sintering step, enabling the carbon content to be lowered more than in the prior art. On the other hand, in cases where the carbon is not entirely removed and a substantial amount remains, the compounds that form together with R, oxygen, nitrogen and the like increase, consuming R and lowering the H_{cJ}. In addition, when heavy rare-earth elements are subjected to grain boundary diffusion, such compounds hinder the diffusion of heavy rare earths to the interior of the magnet, as a result of which a sufficient H_{cJ} may not be attainable particularly at the magnet interior. Given such considerations, the content of carbon, although not particularly limited, is preferably not more than 0.4 at %, more preferably not more than 0.3 at %, and even more preferably not more than 0.2 at %.

The content of nitrogen is not particularly limited. However, to obtain a good H_{cJ}, the content is preferably not more than 0.4 at %, more preferably not more than 0.3 at %, and even more preferably not more than 0.2 at %.

The microstructure of the sintered rare earth magnet of the invention includes R₂T₁₄B intermetallic compounds as the main phase. It also includes a plurality of main-phase grains and grain boundary phases which are positioned between at least two of the main-phase grains and contain the above-described R. M3B₂ and other phases may be included in the grain boundary phases. Moreover, in the sintered rare earth magnet of this invention, R-rich phases may be included in the grain boundary phases and phases of inadvertent impurity compounds such as R carbides, R oxides, R nitrides, R halides and R oxyhalides that are unintentionally introduced in the production steps may also be included, although it is preferable to hold these to the minimum necessary in order to suppress decreases in Bᵣ and H_{cJ}. Of the R-rich phases, those R metal phases with an R content in the range of at least 50% and up to 70% have a high activity because of the high R concentration and, by reacting with the solvent in the subsequently described corrosion resistance test, become starting points of disintegration. Hence, R metal phases account for a proportion of the overall grain boundary phases as a whole that is preferably not more than 3 vol %, and more preferably not more than 1 vol %.

In addition, letting [M1] be the atomic percentage of M1 and [R_{GB}] be the atomic percentage of R which contributes to the formation of grain boundary phases in at least some portion of the range in depth of 0.1 to 200 μm from the surface of the sintered rare earth magnet of the invention, the magnet has a compositional region that satisfies formula (3) below (referred to below as the “high corrosion resistance region”).

1.0<[R_{GB}]/[M1]<2.4 (3)

Here, regarding the depth from the magnet surface, it is difficult to correctly evaluate the composition in regions shallower than 0.1 μm. On the other hand, the composition of regions deeper than 200 μm from the surface do not help to improve the corrosion resistance. Hence, the regions having this specific composition are located within a range in depth of 0.1 to 200 μm from the magnet surface. When there are insufficient grain boundary phases in the above region near the magnet surface, the decrease in [R_{GB}] is accompanied by a decrease in [R_{GB}]/[M1] and a good H_{cJ} cannot be obtained. When surplus M1 elements are present in the above region near the magnet surface, [R_{GB}]/[M1] decreases, as do also Bᵣ and H_{cJ}. In light of the above, [R_{GB}]/[M1] is preferably larger than 1.0, and more preferably larger than 1.2. When surplus R is present in the above region near the magnet surface, [R_{GB}] and [RGS]/[M1] both increase and R metal phases having a high R concentration precipitate in this region, lowering the corrosion resistance. Also, when the M1 concentration in the above region near the magnet surface decreases, [R_{GB}]/[M1] increases and, because the M1 elements that form compounds with R are insufficient, R metal phases having a high R concentration precipitate, lowering the corrosion resistance. From this standpoint, [R_{GB}]/[M1] is preferably smaller than 2.4, and more preferably smaller than 2.2.

The above [R_{GB}] and [M1] can be computed as follows. Letting [R], [Fe], [Co], [Cu], [Ga] and [M1] be the atomic percentages for, respectively, R, iron cobalt, copper, gallium and M1 in the above region, [R_{GB}] is computed from formula (1) below and [M1] is computed from formula (2) below.

[R_{GB}]=[R]−[Fe]/7 (1)

[M1]=[Co]+[Cu]+[Ga] (2)

Also, in this invention, to enhance corrosion resistance by promoting the formation of compounds of R and M1 in the above described high corrosion resistance region near the magnet surface and thereby suppressing the formation of R metal phases, formula (4) below is additionally satisfied in the high corrosion resistance region.

[Cu]+[Ga]≥0.28 (4)

This [Cu]+[Ga] value, from the standpoint of obtaining an optimal temperature range in heat treatment to ensure good productivity and from the standpoint of obtaining a corrosion resistance enhancing effect, is preferably at least 0.28, and more preferably at least 0.35. Although there is no particular upper limit, to stably obtain a high Bᵣ, this value is preferably not more than 1.50, and more preferably not more than 1.00.

Some of the R, iron, cobalt, copper and gallium in the high corrosion resistance region near the magnet surface may be introduced by grain boundary diffusion.

In the sintered rare earth magnet of the invention, the average compositions of R, iron, cobalt, copper and gallium in the high corrosion resistance region at a range in depth of 0.1 to 200 μm from the surface can be verified by using a method of compositional analysis, such as energy-dispersive x-ray spectrometry (EDS), wavelength dispersive x-ray spectrometry (WDS) or glow discharge mass spectrometry (GDMS), and standardizing the results with ICP analysis values. In cases where the surface area of the magnet is sufficiently large, samples of each face to a depth from the surface of 200 μm can be cut out and the average composition determined by ICP analysis. Alternatively, in cases where the sintered rare earth magnet is not one in which the concentration profile for each element changes from the magnet surface toward the interior due to, for example, the application of a grain boundary diffusion process, it is possible to substitute the contents of the metal elements included in the magnet overall as determined by ICP analysis for the average compositions of R, iron, cobalt, copper and gallium in the above-described high corrosion resistance region at a range in depth of 0.1 to 200 μm from the surface of the sintered rare earth magnet.

The sintered rare earth magnet of the invention, as described above, has a region (high corrosion resistance region) where, in at least some portion of the range in depth of 0.1 to 200 μm from the surface, the average composition satisfies above formula (3). In the sintered rare earth magnet of the invention, the corrosion resistance is enhanced by having the above high corrosion resistance region near the surface of the magnet. The broader the high corrosion resistance region relative to the magnet surface area, the higher the corrosion resistance that can be achieved and so, letting S be the surface area of the magnet and S_{R} be the area obtained by projecting the high corrosion resistance region onto the adjoining magnet surface, the magnet preferably satisfies the following formula.

0.53≤S_{R}/S≤1 (5)

S_{R}/S is more preferably at least 0.6. In cases where a high corrosion resistance region has been formed by grain boundary diffusion, S_{R}/S reaches a maximum value of 1 when the various elements have been supplied from all surfaces of the magnet. In cases where grain boundary diffusion is not carried out, S_{R}/S reaches a maximum of 1 when the content of metal elements included in the magnet overall satisfies formula (3). In order to simplify calculations of S_{R}, for a magnet in which grain boundary diffusion has been carried out under identical conditions from only two opposing faces, the average composition of any region at a range in depth from one diffusion face of 0.1 to 200 μm can be treated as a representative value that includes also the opposing diffusion face. The ICP analysis compositions for the base material in which grain boundary diffusion treatment is carried out can be used as the representative value for the non-diffusion faces.

The method for determining S_{R} is not particularly limited, although from the standpoint of simplicity it is preferable to use wavelength dispersive x-ray spectroscopy (WDS). In order to obtain the average composition of a microstructure that includes multiple main phases, grain boundary phases and grain boundary triple junctions, it is preferable for the beam diameter during WDS measurement to be sufficiently larger than the average crystallite size of the magnet to be measured, such as 30 μm or more, and more preferably 50 μm or more. Also, to simplify analysis, it is possible to measure preferably one point at a depth from the surface of 0.1 to 200 μm per 4 mm² of magnet surface area, and more preferably one point at a depth from the surface of 0.1 to 200 μm per 1 mm² of magnet surface area, and to treat the results as representative values. That is, the magnet can be cut or otherwise divided up into pieces measuring from 2 mm×2 mm×2 mm to 1 mm×1 mm×1 mm, and the S_{R} determined by analyzing the divided magnets. The regions lost due to cutting or the like at this time may be subtracted beforehand from the magnet surface area S.

The corrosion resistance in this invention can be evaluated by the following method. A magnet in the shape of a rectangular parallelepiped having dimensions of 5 mm×5 mm×2 mm is cut out from a manufactured magnet and the weight is measured, after which it is immersed and thus sealed in a 1:1 (by volume) ethylene glycol-water mixture and left at rest for 480 hours at 120°C. The magnet is then taken out and degreased with ethanol, ultrasonically cleaned in water and dried, after which the weight of the magnet is measured, giving the post-test weight. From the standpoint of maintaining good magnetic properties after testing, the percent weight loss from corrosion resistance testing obtained by the above method is preferably not more than 1%, and more preferably not more than 0.5%.

Preferably, the smaller the average crystallite size (μm) of the sintered rare earth magnet of the invention in a plane parallel to the direction of magnetization, the smaller the effect of weight loss due to the detachment of grains from the main phase that arises with the disintegration of grain boundary phases in the corrosion resistance test. Also, to obtain a sufficient H_{cJ}, the average crystallite size is preferably not more than 4 μm, and more preferably not more than 3.5 μm. The lower limit of this average crystallite size (μm), from the standpoint of obtaining a sufficient orientation in a suitable range in the amount of lubricant added, is preferably at least 1.2 μm, and more preferably at least 1.8 μm. The average crystallite size in this invention is defined as, for the equivalent circle diameters of individual grains, the area-equivalent median diameter determined from a histogram of the grain size distribution in which the proportion of the surface area occupied by crystallites is plotted in 1 μm increments of average grain spacing. That is, a histogram of the crystallite surface area ratio is prepared from the diameters of the grains calculated as equivalent circle diameters, and the area-equivalent median diameter can be calculated by Gauss function fitting. Measurement of the equivalent circuit diameters of the above-described grains can be carried out by the following procedure. First, a cross-section of the sintered magnet is polished to a mirror surface, after which the magnet is immersed in an etchant such as Virella solution (a glycerol:nitric acid:hydrochloric acid=3:1:2 mixture) and the cross-section in which the grain boundary phases have been selectively etched is examined under a laser microscope. Next, based on the microscopic image thus obtained, the cross-sectional areas of the individual grains are measured by image analysis and the diameters as equivalent circles are computed. The average crystallite size may be set as, for example, the average for a total of about 2,000 grains at 20 different places in the image. The measurement apparatus is not particularly limited. For example, a 3D measuring laser microscope (LEXT OLS 4000, from Olympus Corporation) may be used, and image analysis software (Win ROOF, from Mitani Corporation) may be used for image analysis.

In order to achieve high magnetic properties, the sintered rare earth magnet of the invention is preferably manufactured by a process that reduces to an absolute minimum the level of impurity elements that are included. In this case, the formation of compounds of impurity elements and R is not promoted, facilitating the formation of R metal phases having a high R concentration. Such R metal phases have a low corrosion potential and thus readily become starting points for corrosion. As a result, they invite weight loss, ultimately leading to decreases in the magnetic properties. Methods for suppressing the formation of R metal phases include the method of lowering the R content and the method of including elements other than the impurity elements that readily form compounds with R. The elements added in the latter approach are those referred to above as M1. By adjusting the content of these M1 elements within suitable ranges as described above, it is possible to achieve high magnetic properties and an excellent corrosion resistance.

Next, a method for manufacturing the sintered rare earth magnet of the invention is described. The steps in manufacturing the sintered rare earth magnet of the invention include a melting step which melts the raw materials to obtain a raw-material alloy having a predetermined composition, a milling step which mills the raw-material alloy to produce a fine alloy powder, a pressing step which powder presses the fine alloy powder in an applied magnetic field to form a compact, and a sintering step which heat treats the compact to form a sintered body.

First, in the melting step, metals or alloys serving as the raw materials for the respective elements are weighed out so as to give the predetermined composition. After being weighed out to the predetermined composition, the raw materials are melted by, for example, high-frequency melting and then cooled to produce a raw-material alloy. A melt casting process that casts the alloy in a flat mold or book mold or a strip casting process is generally used to cast the raw-material alloy. Alternatively, in this invention, it is possible to use the so-called two-alloy process which separately produces an alloy close in composition to the R₂Fe₁₄B compound that is the main phase and an R-rich alloy intended to serve as a liquid-phase aid at the sintering temperature, coarsely mills these alloys, and then weighs them out and mixes them together. However, because an alloy close in composition to the main phase has a tendency, depending on the cooling rate during casting and the alloy composition, to undergo α-Fe crystallization, in order to make the microstructure uniform and eliminate the α-Fe phase, it is sometimes preferable to carry out at least one hour of homogenization in a vacuum or an Ar atmosphere at between 700°C and 1200°C. When the alloy close in composition to the main phase is produced by strip casting, homogenization can be omitted. As for the R-rich alloy that serves as a liquid-phase aid, this can be produced by the casting method described above or by the so-called liquid quenching method.

The milling step is a multi-stage step which includes at least a coarse milling step and a fine milling step. A suitable method such as a jaw crusher, Braun mill, pin mill or hydrogen decrepitation may be used in the coarse milling step. In this invention, to lower the amounts of oxygen, nitrogen and carbon and obtain excellent magnetic properties, it is preferable to include a hydrogen decrepitation step as at least one part of the coarse milling step. In this hydrogen decrepitation step, the alloy ingot is exposed to a hydrogen atmosphere at or above a fixed pressure, causing the alloy to absorb hydrogen and break down into a powder. The hydrogen pressure at this time is not subject to any particular limitation. However, to reduce the adverse impact on productivity owing to the fact that hydrogen absorption takes time, the hydrogen pressure is preferably at least 100 kPa. Where necessary, dehydrogenation may be suitably carried out. After the milling step has been carried out by hydrogen decrepitation, the alloy ingot whose temperature has risen is cooled and conveyed to the next step. At this time, to prevent oxidation, it is preferable to cool the ingot to close to room temperature. With such a milling step using hydrogen, it is possible to obtain a coarse-milled powder that is generally from 0.05 mm to 3 mm, and especially from 0.05 mm to 1.5 mm, in size.

In the fine milling step, a method which uses a jet mill to mill the coarse powder obtained in the above coarse milling step under a stream of non-oxidizing gas such as nitrogen, helium or argon may be employed. In this invention, the fine milling step mills the above coarse powder to a volume-based median diameter D50 of preferably from 0.2 to 10 μm, more preferably from 1.2 to 4.0 μm, and even more preferably from 1.5 to 3.5 μm. The oxygen and nitrogen in the sintered rare earth magnet are unintentionally introduced primarily in the fine milling step, and so control of the jet mill atmosphere is necessary in order to adjust the oxygen and nitrogen contents within the sintered rare earth magnet. For example, adjustment of the oxygen content within the sintered rare earth magnet is carried out by controlling the amount of oxygen and the dew point in the jet mill atmosphere. The amount of moisture in the atmosphere during milling is set to preferably 100 ppm or less, and the oxygen concentration is set to preferably 1 ppm or less. As used herein, the volume-based median diameter D50 refers to the particle size when the cumulative volumetric frequency reaches 50%.

The nitrogen content in the sintered rare earth magnet can be adjusted by, for example, (A) carrying out fine milling with a jet mill under a stream of helium or argon gas, (B) introducing hydrogen into a jet mill and carrying out fine milling, all under a stream of N₂ gas, or (C) using a hydrogen-containing coarse powder and carrying out fine milling in a jet mill under a stream of N₂ gas. Here, with method (B) or (C), by introducing hydrogen gas or using a hydrogen-containing coarse powder, hydrogen is preferentially adsorbed to the active surfaces formed by milling, hindering the adsorption of nitrogen and thus making it possible to lower the amount of nitrogen in the sintered rare earth magnet.

The hydrogen-containing coarse powder in above method (C) may be prepared by, for example, omitting dehydrogenation treatment in the above-described hydrogen decrepitation step or causing hydrogen to be absorbed in the coarse powder following dehydrogenation treatment, or by causing hydrogen to be absorbed in the coarse powder obtained by mechanical milling in helium or argon gas atmosphere. From the standpoint of lowering the nitrogen content, the hydrogen content of the coarse powder or the fine powder after milling is preferably from 0.1 to 1.0 wt %, and more preferably from 0.2 to 0.5 wt %. The hydrogen content of the coarse powder or the fine powder after milling can be determined by measuring the weight change before and after hydrogen absorption.

A lubricant composed of a saturated fatty acid or an ester thereof may be suitably added to the above milling step, either before or after the coarse milling step, in order to increase powder orientability in the subsequent step, i.e., powder pressing within a magnetic field. Although lubricant addition is effective for enhancing orientation, this causes a dilemma; namely, the H_{cJ} markedly decreases owing to the formation of much R—OCN phase in the sintered rare earth magnet on account of carbon from the lubricant. Hence, in order to suppress a decrease in H_{cJ}, it is preferable to add a lubricant when employing above method (C). In the sintered rare earth magnet manufactured by such a method, when hydrogen contained at the interior is desorbed at the time of heat treatment, the lubricant that chemically adsorbs to the surface of the fine powder by means of this hydrogen decomposes due to, for example, a carbonyl reduction reaction. In addition, it is thought that the carbon content remaining in the sintered rare earth magnet can be lowered owing to the effect of lubricant decomposition and disassociation to highly volatile lower alcohols by cracking reactions involving hydrogen gas. The amount of this lubricant added is suitably set according to the type of lubricant and other considerations and is not particularly limited. However, the addition of from 0.01 to 0.50 part by weight per 100 parts by weight of the coarsely milled powder or the raw-material alloy is preferred; the addition of from 0.05 to 0.30 part by weight is more preferred.

In the above pressing step, the alloy powder is powder pressed with a press while applying a magnetic field of, e.g., from 400 to 1,600 kA/m and thereby orienting the alloy powder in the direction of easy magnetization. The density of the compact formed at this time is preferably set to from 2.8 to 4.2 g/cm³. That is, to ensure the strength of the compact and obtain good handleability, the density of the compact is preferably set to at least 2.8 g/cm³. A binder such as PVA or a fatty acid may be added to increase the strength of the pressed compact. At the same time, to obtain a sufficient compact strength and also obtain a suitable Bᵣ by suppressing misorientation of the grains during pressing, the compact density is preferably not more than 4.2 g/cm³. Also, to suppress oxidation of the fine alloy powder, pressing is preferably carried out in an inert gas atmosphere such as nitrogen gas or argon gas.

The sintering step sinters the compact obtained in the pressing step within an inert gas atmosphere such as argon gas or within a high vacuum. This step preferably includes an atmospheric heat treatment step that carries out heat treatment in an inert gas atmosphere and a vacuum heat treatment step that carries out heat treatment in a vacuum atmosphere. In cases where a hydrogen-containing coarse powder obtained by method (C) above is used, to suppress a temperature drop in the compact accompanying the release of hydrogen gas within the compact (endothermic reaction) and also suppress crack generation due to temperature differences, in the atmospheric heat treatment step, although not particularly limited, the compact is preferably held in an inert gas atmosphere at between 300°C and 600°C for a period of from 1 hour to 10 hours. Thereafter, in the vacuum heat treatment step, although not particularly limited, the compact is preferably held in a high vacuum at between 950°C and 1200°C for a period of from 0.5 hour to 10 hours.

In the practice of the invention, after an atmospheric heat treatment step and a vacuum heat treatment step have been successively carried out in the sintering step, the resulting sintered body may then be subjected to heat treatment at a temperature lower than the above sintered temperature and a grain boundary diffusion step in order to increase the H_{cJ}. This heat treatment at a temperature lower than the sintering temperature may be carried out as a two-stage heat treatment consisting of high-temperature heat treatment and low-temperature heat treatment, or may be carried out as solely low-temperature heat treatment. In high-temperature heat treatment, the sintered body is heat-treated at a temperature of preferably between 600°C and 950°C. In low-temperature heat treatment, the sintered body is heat-treated at a temperature of preferably between 400°C and 600°C.

The grain boundary diffusion step may be carried out so as to increase the H_{cJ} of the sintered body that has been obtained and also to form a high corrosion resistance region. This step includes a diffusion source furnishing step which makes a diffusion source present on the surface of the sintered body and a diffusion heat treatment step that heat treats the sintered body and the diffusion source in a vacuum or in an inert gas atmosphere.

The composition of the diffusion source is not particularly limited, and may be suitably selected according to, for example, the above-described objectives. In this case, for example, the H_{cJ} which improves the anisotropic magnetic field at the surfaces of the magnet main-phase grains can be increased by including, for example, R2 (R2 being one or more element selected from dysprosium and terbium), or the corrosion resistance of the magnet can be increased by including M1 (M1 being one or more element selected from cobalt, copper and gallium).

A known method may be used in the above diffusion source furnishing step. For example, a powder of the diffusion source may be dispersed in an organic solvent such as alcohol or in water to form a slurry, after which the sintered body is immersed in this slurry and then pulled out and subsequently dried with warm air or in a vacuum or simply air dried. Alternatively, a powder of the diffusion source may be mixed together with a resin slurry and stirred, then formed into a sheet and attached to the sintered body.

Next, in the diffusion heat treatment step, the condition that R2 concentrates near grain boundaries within the magnet main phases is preferable for obtaining a sufficient coercivity-enlarging effect, and the condition that M1 concentrates within a range in depth of 0.1 to 200 μm from the surface of the magnet so as to satisfy above formulas (3) and (5) is preferable for increasing the corrosion resistance. Although not particularly limited, the condition of diffusing the R2 element and/or the M1 elements to the sintered body under heating to a temperature above 400°C, and especially at least 500°C, but not more than 1100°C, especially not more than 1050°C, and particularly not more than 1000°C, is preferred. To avoid modification of the sintered body microstructure, or adverse effects on the magnetic properties and corrosion resistance due to unavoidable oxidation or component evaporation, the heat treatment time is preferably set to from 1 minute to 50 hours. Also, it is preferable to apply the diffusion source to at least 53% of the overall surface area of the magnet such that the surface area of the high corrosion resistance region satisfies formula (5).

### EXAMPLES

The invention is illustrated more fully below by way of Examples and Comparative Examples, although the invention is not limited by these Examples.

### Examples 1 to 3, Comparative Examples 1 to 3

A raw-material alloy in the form of flakes having a thickness of 0.2 to 0.4 mm was obtained by weighing out and blending neodymium metal, ferroboron alloy, electrolytic cobalt, aluminum metal, copper metal, gallium metal, zirconium metal and electrolytic iron (the metals all having purities of at least 99%) so as to arrive at the predetermined proportions, and then melting and strip casting the mixture. The flaked raw-material alloy was hydrogen decrepitated in a hydrogen pressurized atmosphere, giving a coarsely milled powder. Next, 0.1 part by weight of stearic acid as a lubricant was added to and mixed in with 100 parts by weight of the coarsely milled powder, following which a jet mill was used to carry out dry milling in a stream of nitrogen, giving a finely milled powder (alloy powder) having a milled particle size (D50) of 2.9 μm. The milled particle size (D50) is the volume-based median diameter obtained via laser diffraction analysis by the air flow dispersion method. This finely milled powder was filled into the mold of a press under an N₂ gas atmosphere and, while orienting the powder in a 15 kOe (1.19 MA/m) magnetic field, was pressed in a direction perpendicular to the magnetic field. The density of the resulting powder compact was 3.0 to 4.0 g/cm³. Next, atmospheric heat treatment was carried out in which the resulting compact was heated to 500°C in an Ar gas atmosphere and heat treated, following which the compact was sintered by carrying out a vacuum heat treatment step in a vacuum and at between 1040°C and 1080°C (a temperature being selected at which densification due to sintering fully arises in each sample) for 5 hours, thereby giving a neodymium magnet material.

The density of the resulting neodymium magnet was 7.5 g/cm³ or more. Metal constituent analysis was carried out on the center portion of the resulting magnet using high-frequency inductively coupled plasma-optical emission spectroscopy (ICP-OES). In addition, the oxygen concentration was measured by the inert gas fusion infrared absorption method, the nitrogen concentration was measured by the inert gas fusion thermal conductivity method, and the carbon concentration was measured by the combustion infrared absorption method. The results are presented in Table 1. The values in Table 1 are atomic percentages.

The microstructures of the resulting magnets were examined with an electron probe microanalyzer (EPMA). The R metal phases were identified from backscattered electron images and the results of semiquantitative analysis, and the proportion of R metal phase included in all the grain boundary phases of the magnet was measured by image processing. The results are shown in Table 2.

In addition, test specimens in the shape of perpendicular parallelepipeds having dimensions of 5 mm (L)×5 mm (W)×2 mm (T, this being the direction of magnetization) were cut from the resulting magnets, and corrosion resistance evaluations were carried out. During evaluation, the cutout magnet was immersed and sealed in an ethylene glycol-water mixture (ethylene glycol:water=1:1 by volume) as a stand-in for antifreeze and held at 120°C. The specimen was taken out after 480 hours had elapsed and the weight was measured. The percent weight loss was calculated by comparing this weight with the weight before immersion. The results are shown in Table 2.

In addition, the magnets obtained were cut out in the shape of rectangular parallelepipeds having dimensions of 15 mm (L)×7 mm (W)×12 mm (T, direction of magnetization), and Bᵣ and He were measured with a B-H tracer. The results are shown in Table 2. Table 2 shows the formula (3) and (4) calculated values specified in this invention. In Examples 1 to 3 and Comparative Examples 1 to 3, grain boundary diffusion treatment was not carried out and so it is assumed that there was no change in the concentration gradients from the magnet surface to the interior. Hence, the average compositions of R, iron, cobalt, copper and gallium in the range in depth of 0.1 to 200 μm from the surface were substituted with the contents of the metallic elements included in the overall magnet as determined by ICP-OES analysis. The region for which this was done was the entire surface of the magnet.

The average crystallite sizes (μm) of the resulting magnets were measured with a laser microscope and found to be 3.5 μm in each of Examples 1 to 3 and Comparative Examples 1 to 3.

TABLE 1
(at %)

| | Nd | Fe | B | Co | Cu | Ga | Al | Zr | O | C | N |
|---|---|---|---|---|---|---|---|---|---|---|---|
| Example 1 | 12.78 | 79.76 | 6.02 | 0.50 | 0.19 | 0.29 | 0.27 | 0.14 | 0.32 | 0.13 | 0.07 |
| Example 2 | 13.18 | 79.22 | 6.16 | 0.50 | 0.20 | 0.29 | 0.31 | 0.14 | 0.39 | 0.12 | 0.06 |
| Example 3 | 13.57 | 78.89 | 6.08 | 0.50 | 0.21 | 0.29 | 0.32 | 0.14 | 0.38 | 0.12 | 0.08 |
| Comparative | 14.03 | 78.54 | 6.05 | 0.49 | 0.19 | 0.29 | 0.27 | 0.14 | 0.30 | 0.19 | 0.23 |
| Example 1 | | | | | | | | | | | |
| Comparative | 14.62 | 77.95 | 6.08 | 0.50 | 0.20 | 0.30 | 0.30 | 0.14 | 0.32 | 0.12 | 0.08 |
| Example 2 | | | | | | | | | | | |
| Comparative | 15.51 | 76.90 | 6.08 | 0.50 | 0.20 | 0.30 | 0.30 | 0.14 | 0.31 | 0.12 | 0.08 |
| Example 3 | | | | | | | | | | | |

TABLE 2

| | R metal | Weight | | | | |
|---|---|---|---|---|---|---|
| | phase pro- | loss | Bᵣ | H_{cJ} | Formula | Formula |
| | portion (%) | ratio (%) | (kG) | (kOe) | (3) | (4) |
| Example 1 | 0 | 0.01 | 14.77 | 12.66 | 1.41 | 0.48 |
| Example 2 | 0 | 0.02 | 14.59 | 13.17 | 1.88 | 0.49 |
| Example 3 | 0 | 0.01 | 14.45 | 13.71 | 2.30 | 0.50 |
| Comparative | 4 | 3.60 | 14.11 | 14.44 | 2.90 | 0.48 |
| Example 1 | | | | | | |
| Comparative | 7 | 10.27 | 13.90 | 15.03 | 3.49 | 0.50 |
| Example 2 | | | | | | |
| Comparative | 11 | 15.11 | 13.42 | 15.67 | 4.53 | 0.50 |
| Example 3 | | | | | | |

On comparing Examples 1 to 3 with Comparative Examples 1 to 3, when the amount of neodymium is low, the formula (3) condition is satisfied, R metal phases are not confirmed to be present in the grain boundary phases, and substantially no weight loss is observable. On the other hand, when the amount of neodymium increases, the formula (3) condition is not satisfied, the presence of R metal phases is confirmed in the grain boundary phases, and the weight loss ratio is high. The reason appears to be that the corrosion potential of the R metal phases was low and corrosion in the ethylene glycol-water mixture readily proceeded.

### Examples 4 to 6, Comparative Examples 4 to 6

Magnets were manufactured in the same way as in Example 1. Metal constituent analysis was carried out on the resulting magnets using ICP-OES. In addition, the oxygen concentration was measured by the inert gas fusion infrared absorption method, the nitrogen concentration was measured by the inert gas fusion thermal conductivity method, and the carbon concentration was measured by the combustion infrared absorption method. The results are presented in Table 3. The proportion of R metal phases and the percent weight loss in the corrosion resistance evaluation test were calculated in the same way as in Example 1. The results are shown in Table 4. Table 4 also shows the formula (3) and (4) calculated values specified in the invention. In Examples 4 to 6 and Comparative Examples 4 to 6, grain boundary diffusion treatment was not carried out and so it is assumed that there was no change in the concentration gradient from the magnet surface to the interior. Hence, the average compositions of R, iron, cobalt, copper and gallium in the range in depth of 0.1 to 200 μm from the surface were substituted with the contents of the metal elements included in the overall magnet as determined by ICP-OES analysis. The region for which this was done was the entire surface of the magnet.

The average crystallite sizes (μm) of the resulting magnets were measured with a laser microscope and found to be 3.5 μm in each of Examples 4 to 6 and Comparative Examples 4 to 6.

TABLE 3
(at %)

| | Nd | Fe | B | Co | Cu | Ga | Al | Zr | O | C | N |
|---|---|---|---|---|---|---|---|---|---|---|---|
| Comparative | 14.11 | 78.92 | 6.00 | 0.02 | 0.20 | 0.29 | 0.22 | 0.15 | 0.26 | 0.19 | 0.18 |
| Example 4 | | | | | | | | | | | |
| Example 4 | 14.11 | 77.98 | 6.06 | 0.98 | 0.19 | 0.29 | 0.25 | 0.15 | 0.28 | 0.18 | 0.20 |
| Example 5 | 14.16 | 77.44 | 6.06 | 1.46 | 0.19 | 0.29 | 0.25 | 0.15 | 0.24 | 0.17 | 0.21 |
| Example 6 | 14.14 | 76.95 | 6.06 | 1.98 | 0.19 | 0.29 | 0.25 | 0.15 | 0.24 | 0.19 | 0.22 |
| Comparative | 14.17 | 75.92 | 6.07 | 2.96 | 0.19 | 0.29 | 0.25 | 0.15 | 0.27 | 0.18 | 0.21 |
| Example 5 | | | | | | | | | | | |
| Comparative | 14.15 | 73.95 | 6.00 | 4.95 | 0.19 | 0.30 | 0.22 | 0.15 | 0.27 | 0.17 | 0.18 |
| Example 6 | | | | | | | | | | | |

TABLE 4

| | R metal | Weight | | | | |
|---|---|---|---|---|---|---|
| | phase pro- | loss | Bᵣ | H_{cJ} | Formula | Formula |
| | portion (%) | ratio (%) | (kG) | (kOe) | (3) | (4) |
| Comparative | 15 | 27.77 | 14.11 | 14.51 | 5.56 | 0.49 |
| Example 4 | | | | | | |
| Example 4 | 0 | 0.07 | 14.16 | 14.44 | 2.03 | 0.48 |
| Example 5 | 0 | 0.04 | 14.14 | 14.26 | 1.60 | 0.48 |
| Example 6 | 0 | 0.07 | 14.14 | 14.02 | 1.28 | 0.48 |
| Comparative | 0 | 0.04 | 14.09 | 13.50 | 0.97 | 0.48 |
| Example 5 | | | | | | |
| Comparative | 0 | 0.01 | 14.06 | 13.75 | 0.66 | 0.49 |
| Example 6 | | | | | | |

On comparing Examples 4 to 6 with Comparative Examples 4 to 6, it is apparent that when the formula (3) condition is satisfied, R metal phases are not confirmed, substantially no weight loss is observable, and high Bᵣ and R values are obtained. On the other hand, when the [R_{GB}]/[M1] value is 2.4 or more (Comparative Example 4), the proportion of R metal phases is high and the percent weight loss is also high, indicating a poor corrosion resistance. In cases where the [R_{GB}]/[M1] value is 1.0 or less (Comparative Examples 5 and 6), it is apparent that the R has decreased.

### Examples 7 to 12, Comparative Example 7

Magnets were manufactured in the same way as in Example 1. Metal constituent analysis was carried out on the resulting magnets using ICP-OES. In addition, the oxygen concentration was measured by the inert gas fusion infrared absorption method, the nitrogen concentration was measured by the inert gas fusion thermal conductivity method, and the carbon concentration was measured by the combustion infrared absorption method. The results are presented in Table 5. The proportion of R metal phases and the percent weight loss in the corrosion resistance evaluation test were calculated in the same way as in Example 1. The results are shown in Table 6. Table 6 also shows the formula (3) and (4) calculated values specified in the invention. In Examples 7 to 12 and Comparative Example 7, grain boundary diffusion treatment was not carried out and so it is assumed that there was no change in the concentration gradient from the magnet surface to the interior. Hence, the average compositions of R, iron, cobalt, copper and gallium in the range in depth of 0.1 to 200 μm from the surface were substituted with the contents of the metal elements included in the overall magnet as determined above by ICP-OES analysis. The region for which this was done was the entire surface of the magnet.

The average crystallite sizes (μm) of the magnets obtained were measured with a laser microscope and found to be 3.5 μm in each of Examples 7 to 12 and Comparative Example 7.

TABLE 5
(at %)

| | Nd | Fe | B | Co | Cu | Ga | Al | Zr | O | C | N |
|---|---|---|---|---|---|---|---|---|---|---|---|
| Comparative | 14.10 | 77.17 | 6.11 | 2.03 | 0.19 | 0 | 0.24 | 0.14 | 0.38 | 0.18 | 0.17 |
| Example 7 | | | | | | | | | | | |
| Example 7 | 14.18 | 77.07 | 6.07 | 2.00 | 0.29 | 0 | 0.27 | 0.15 | 0.26 | 0.17 | 0.14 |
| Example 8 | 14.09 | 77.13 | 6.09 | 2.01 | 0.19 | 0.09 | 0.24 | 0.14 | 0.35 | 0.18 | 0.17 |
| Example 9 | 14.10 | 77.03 | 6.10 | 1.99 | 0.19 | 0.18 | 0.24 | 0.14 | 0.31 | 0.17 | 0.17 |
| Example 10 | 14.16 | 76.72 | 6.11 | 2.02 | 0.19 | 0.37 | 0.27 | 0.14 | 0.27 | 0.16 | 0.17 |
| Example 11 | 14.18 | 76.66 | 6.11 | 1.99 | 0.19 | 0.46 | 0.24 | 0.14 | 0.27 | 0.15 | 0.15 |
| Example 12 | 14.16 | 76.79 | 6.05 | 2.00 | 0.29 | 0.20 | 0.27 | 0.15 | 0.27 | 0.17 | 0.17 |

TABLE 6

| | R metal | Weight | | | | |
|---|---|---|---|---|---|---|
| | phase pro- | loss | Bᵣ | H_{cJ} | Formula | Formula |
| | portion (%) | ratio (%) | (kG) | (kOe) | (3) | (4) |
| Comparative | 5 | 28.19 | 14.17 | 14.08 | 1.39 | 0.19 |
| Example 7 | | | | | | |
| Example 7 | 0 | 0.05 | 14.14 | 14.03 | 1.38 | 0.29 |
| Example 8 | 0 | 0.02 | 14.18 | 14.06 | 1.34 | 0.28 |
| Example 9 | 0 | 0.03 | 14.12 | 14.28 | 1.31 | 0.37 |
| Example 10 | 0 | 0.01 | 14.04 | 14.09 | 1.24 | 0.56 |
| Example 11 | 0 | 0.01 | 14.01 | 14.20 | 1.22 | 0.65 |
| Example 12 | 0 | 0.02 | 14.11 | 14.29 | 1.28 | 0.49 |

On comparing Examples 7 to 12 with Comparative Example 7, it is apparent that all of the magnets satisfy the relationship in formula (3). In Comparative Example 7, which does not satisfy the relationship in formula (4), the proportion of R metal phases is high and the percent weight loss is also high. This appears to be a result brought about by the fact that the formation of compounds of R with copper or gallium was not promoted and the formation of R metal phases could not be suppressed.

### Examples 13 and 14

Terbium metal, electrolytic iron, electrolytic cobalt and gallium metal were weighed out and blended in atomic ratios of 1:1:1 and these raw materials were melted in an arc melting furnace to give TbFeGa and TbFeCo alloy ingots, following which the alloy ingots were heat treated for 10 hours at 1050°C in a vacuum atmosphere. The heat-treated alloy ingots were milled in a ball mill, preparing alloy powders having a D50 of about 10 μm. The alloy powder was mixed together with a water-soluble PVA resin slurry in a 7:3 ratio and stirred, then formed to a thickness of 50 μm and dried, thereby fabricating TbFeGa alloy sheets and TbFeCo alloy sheets.

Next, magnets similar to that in Comparative Example 1 were manufactured. The magnets thus obtained were cut to dimensions of 17 mm (L)×19 mm (W)×2.2 mm (T), TbFeGa alloy sheets (Example 13) and TbFeCo alloy sheets (Example 14) were attached to the LW faces perpendicular to the direction of magnetization, following which the magnet was held at 900°C for 20 hours in a vacuum atmosphere and then slowly cooled to 300°C. The temperature was subsequently raised to 450°C and the magnet was held at that temperature for 2 hours, after which it was rapidly cooled to 300°C. In order to determine the average composition at a depth of 0.1 to 200 μm from the surface on the diffusion faces of the resulting magnets by wavelength diffusion x-ray spectrometry (WDS), the center portion of the base material in the manufactured magnet where diffusion treatment had not been carried out was measured in ten places by WDS at a beam diameter of 50 μm, and corrected values for the WDS measurements were set based on the average analysis values for these measurements and the ICP analysis values for the base material. The results are shown in Table 7.

Next, to determine the average compositions at a depth of 0.1 to 200 μm from the surface on the diffusion faces of the resulting magnets, measurements at positions 125 μm deep from the diffusion face were taken at ten places by WDS at a beam diameter of 50 μm and averaged, correction was carried out based on the corrected values in Table 7, and [R_{GB}]/[M1] was calculated. Those results are shown in Table 8. In addition, the proportion of R metal phases and the percent weight loss in the corrosion resistance evaluation test were calculated in the same way as in Example 1. Those results are shown in Table 8. To calculate S_{R}/S, the surface area S was calculated for the sample cut to a thickness T of 2.2 mm at the time of grain boundary diffusion and in the shape of a 5 mm (L)×5 mm (W) rectangular parallelepiped shape for corrosion resistance evaluation, and S_{R} was calculated as the sum of the two 5 mm (L)×5 mm (W) faces which are the diffusion faces of that shape. The results are shown in Table 8. In addition, the measured values for Comparative Example 1 shown in Table 2 above have been reproduced in Table 8.

The average crystallite sizes (μm) of the magnets obtained were measured with a laser microscope and found to be 3.5 μm in both Examples 13 and 14.

TABLE 7
(at %)

| | Method | | | | | | | | | | | | |
|---|---|---|---|---|---|---|---|---|---|---|---|---|---|
| | of analysis | Nd | Tb | Fe | B | Co | Cu | Ga | Al | Zr | O | C | N |
| Base | ICP | 14.03 | 0 | 78.54 | 6.05 | 0.49 | 0.19 | 0.29 | 0.27 | 0.14 | 0.30 | 0.19 | 0.23 |
| material | | | | | | | | | | | | | |
| Base | WDS | 9.25 | 0.18 | 53.80 | 13.17 | 0.80 | 0.52 | 0.83 | 0.99 | 0.42 | 3.46 | 5.59 | 10.99 |
| material | | | | | | | | | | | | | |
| Difference | — | 4.78 | −0.18 | 24.74 | −7.12 | −0.31 | −0.33 | −0.54 | −0.72 | −0.28 | −3.16 | −5.40 | −10.76 |

TABLE 8

| | Diffusion | R metal phase | Weight loss | Formula | Formula | Formula |
|---|---|---|---|---|---|---|
| | source | Proportion (%) | ratio (%) | (3) | (4) | (5) |
| Example 13 | TbFeGa | 0 | 0.01 | 2.35 | 0.60 | 0.53 |
| Example 14 | TbFeCo | 0 | 0.01 | 2.15 | 0.61 | 0.53 |
| Comparative | — | 4 | 3.60 | 2.90 | 0.48 | 0 |
| Example 1 | | | | | | |

On comparing Comparative Example 1 with Examples 13 and 14, although the corrosion resistance was not satisfied in the base material (Comparative Example 1), the corrosion resistance was found to improve with grain boundary diffusion treatment. The reason is thought to be that the gallium and cobalt included in the diffusion source are introduced into the base material, causing a change in the calculated value for [R_{GB}]/[M1] before and after boundary grain diffusion and an improvement in the corrosion resistance. Also, in Examples 13 and 14, because the S_{R}/S value satisfies the relationship in formula (5) and sufficient high corrosion resistance regions are present relative to the magnet surface area, the magnet appears to have sufficient corrosion resistance.

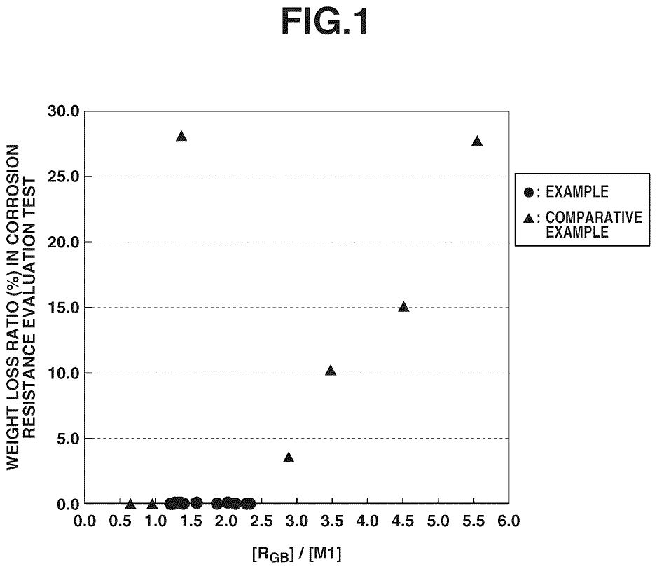

FIG. 1 shows a graph of the relationship between [R_{GB}]/[M1] and the weight loss ratio in Examples 1 to 14 and Comparative Examples 1 to 7. In this graph, the Examples according to the invention are indicated by closed circles (●) and the Comparative Examples are indicated by closed triangles (▴). From this graph, it is apparent that when the value of [R_{GB}]/[M1] is 2.4 or more, the corrosion resistance worsens. On the other hand, when the value of [R_{GB}]/[M1] is 1.0 or less, the corrosion resistance is good, but the magnetic properties worsen (Comparative Examples 5 and 6). Also, in a case where the value of [R_{GB}]/[M1] satisfies formula (3) but formula (4) is not satisfied, the corrosion resistance worsens (Comparative Example 7).

In cases where grain boundary diffusion treatment was carried out (Examples 13 and 14), it was confirmed that, owing to the introduction of M1 elements included in the diffusion source, the [R_{GB}]/[M1] value for the base material which did not satisfy formula (3) (Comparative Example 1) became smaller, falling to 2.4 or less and thus enabling sufficient corrosion resistance to be achieved.

The above demonstrates that the magnets in Examples 1 to 14 which satisfy the conditions of the invention show substantially no weight loss in corrosion resistance evaluation tests and have high magnetic properties and a satisfactory corrosion resistance.

1. A sintered rare earth magnet comprising R (wherein R is one or more element selected from the rare earth elements, with neodymium being essential), iron, boron, M1 (wherein M1 is two or more elements selected from cobalt, copper and gallium, with cobalt being essential), M2 (wherein M2 is one or more element selected from aluminum, silicon, chromium, manganese, zinc, germanium, molybdenum, tin, tungsten, lead and bismuth) and oxygen,
wherein the oxygen is included in an amount of 0.6 at % or less, and
the sintered rare earth magnet has a plurality of main-phase grains consisting of a R₂Fe₁₄B intermetallic compound, an R-containing grain boundary phase positioned between at least two of the main-phase grains, and a region which, letting [R], [Fe], [Co], [Cu], [Ga] and [M1] be the atomic percentages of, respectively, R, iron, cobalt, copper, gallium and M1 in at least some portion of the range in depth of 0.1 to 200 μm from a surface of the magnet and letting [R_{GB}] be the atomic percentage of R which contributes to formation of the grain boundary phase, satisfies formulas (1) to (4) below.
[R_{GB}]=[R]−[Fe]/7 (1)
[M1]=[Co]+[Cu]+[Ga] (2)
1.0<[R_{GB}]/[M1]<2.4 (3)
[Cu]+[Ga]≥0.28 (4)

2. The sintered rare earth magnet of claim 1 wherein, letting S be the surface area of the magnet and S_{R} be the surface area obtained by projecting onto an adjoining surface of the magnet the region that satisfies formulas (1) to (4) in the range in depth of 0.1 to 200 μm from the magnet surface, the sintered rare earth magnet satisfies formula (5) below.
0.53≤S_{R}/S≤1 (5)

3. The sintered rare earth magnet of claim 1, wherein the content of R metal phase having an R content of from 50 to 70 at % within the grain boundary phase is 3 vol % or less.

4. The sintered rare earth magnet of claim 1, further comprising from 0.1 to 2.0 at % of M3 (wherein M3 is one or more element selected from titanium, vanadium, zirconium, niobium, hafnium and tantalum).

5. The sintered rare earth magnet of claim 4 wherein, letting [B] be the atomic percentage of boron and [M3] be the atomic percentage of M3, the magnet satisfies formula (6) below.
[B]−2×[M3]≥[Fe]/14 (6)

6. The sintered rare earth magnet of claim 1, wherein the carbon is included in an amount of 0.4 at % or less.

7. The sintered rare earth magnet of claim 1, wherein the nitrogen is included in an amount of 0.4 at % or less.

8. The sintered rare earth magnet of claim 1, wherein the main-phase grains have an average crystallite size, determined as the equivalent circle diameter in a plane parallel to the direction of magnetization, of 4 μm or less.

9. The sintered rare earth magnet of claim 1, wherein the magnet has a percent weight loss, as determined by the method of immersing and sealing, in a 1:1 by volume ethylene glycol-water mixture, a sample cut from the magnet in the shape of a rectangular parallelepiped having dimensions of 5 mm×5 mm×2 mm, holding the immersed sample in the sealed state at 120°C for 480 hours and measuring the percent loss in the sample weight, of 1 wt % or less.
